(19) United States
(12) Patent Application Publication
(10) Pub. No.: US 2025/0278261 A1
(43) Pub. Date: Sep. 4, 2025

(54) NON-TRANSITORY COMPUTER-READABLE RECORDING MEDIUM STORING COMPUTER-READABLE INSTRUCTIONS FOR TERMINAL DEVICE, TERMINAL DEVICE, AND CONTROL METHOD FOR TERMINAL DEVICE

(71) Applicant: BROTHER KOGYO KABUSHIKI KAISHA, Nagoya (JP)

(72) Inventor: Masayuki YATAGAI, Nagoya (JP)

(21) Appl. No.: 19/058,129

(22) Filed: Feb. 20, 2025

(30) Foreign Application Priority Data
Feb. 29, 2024 (JP) 2024-030450

(51) Int. Cl. G06F 8/65; H04N 1/00; H04N 1/44

(52) U.S. Cl. CPC G06F 8/65; H04N 1/00413; H04N 1/00973; H04N 1/4413; H04N 2201/0094

(57) ABSTRACT

A terminal device may comprise: a display; a communication interface; and a controller configured to: cause the display to display an input screen including a first input field for setting a time setting value indicating a time when a device, which is configured to communicate with via the communication interface, is to execute an automatic update function, wherein the automatic update function is a function for automatically updating a device program stored in the device at a time indicated by the time setting value; and send a value inputted in the first input field to the device via the communication interface, wherein the value inputted in the first input field is used in the device as the time setting value.

### REFERENCE TO RELATED APPLICATION

This application claims priority to Japanese Patent Application No. 2024-030450 filed on Feb. 29, 2024. The entire content of the priority application is incorporated herein by reference.

### BACKGROUND ART

An automatic update function of automatically updating firmware in a communication device is known.

### SUMMARY

The disclosure herein provides a technology that facilitates setting a time when an automatic update process for automatically updating a device program is to be executed.

A non-transitory computer-readable recording medium storing computer-readable instructions for a terminal device is disclosed herein. The computer-readable instructions, when executed by a processor of the terminal device, may cause the terminal device to: cause a display of the terminal device to display an input screen including a first input field for setting a time setting value indicating a time when a device being configured to communicate with the terminal device is to execute an automatic update function, the input screen being generated according to the computer-readable instructions, and the automatic update function being a function for automatically updating a device program stored in the device at a time indicated by the time setting value; and send a value inputted in the first input field to the device via a communication interface of the terminal device, the value inputted in the first input field being used in the device as the time setting value.

According to the configuration above, a user can set the time setting value using the terminal device. The user can thus set the time when the automatic update function is to be executed, using the terminal device which is easier to operate than the device.

The above terminal device itself and a control method for the terminal device are also novel and useful.

### BRIEF DESCRIPTION OF DRAWINGS

FIG. 1 shows a block diagram of a communication system.

FIG. 2 shows a flowchart of a home screen process.

FIG. 3 shows a flowchart of an update process.

FIG. 4 shows a flowchart of an automatic update setting process.

FIG. 5 schematically shows screens.

FIG. 6 schematically shows screens.

FIG. 7 schematically shows screens.

FIG. 8 schematically shows screens.

FIG. 9 schematically shows screens.

### DESCRIPTION

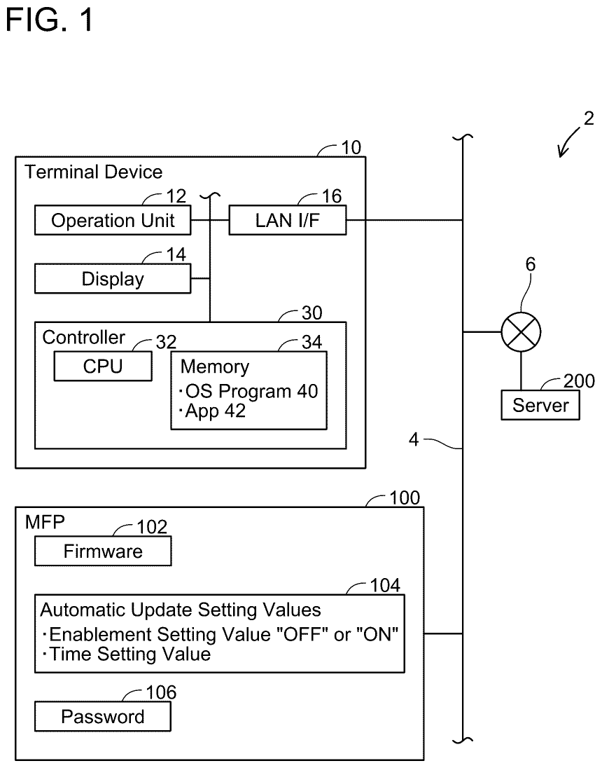

### Configuration of Communication System 2: FIG. 1

A communication system 2 comprises a terminal device 10, a multifunction peripheral (MFP) 100, and a server 200. The terminal device 10 is a smartphone, a tablet terminal, a laptop PC, a desktop PC, or the like. The MFP 100 is a multifunctional device configured to execute multiple functions including a print function and a scan function. The terminal device 10 is communicable with the MFP 100 via a local area network (LAN) 4. The LAN 4 is a wired LAN or a wireless LAN. The LAN 4 is connected to the internet 6. The server 200 is established on the internet 6.

The MFP 100 comprises a print engine and a scanner engine. The print engine is a mechanism for printing images on paper and includes, for example, a print head. A print scheme of the print engine is an inkjet scheme, an electrophotographic scheme, a thermal scheme, or the like. The MFP 100 executes a print process using the print engine when receiving print data from the terminal device 10. The scanner engine is a mechanism for reading images on paper and includes an image sensor and the like. The MFP 100 executes a scan process using the scanner engine when receiving a scan request from the terminal device 10.

### Configuration of Terminal Device 10: FIG. 1

The terminal device 10 comprises an operation unit 12, a display 14, a LAN interface 16, and a controller 30. Hereinafter, an interface is abbreviated as “I/F”.

The operation unit 12 is a user interface for a user to input various information to the terminal device 10. The operation unit 12 comprises a touch screen for displaying software keys (so-called operation objects), hardware keys such as a keyboard and a mouse, or both of these. The display 14 is configured to display various information. The display 14 is, for example, a liquid crystal display or an organic EL display. The display 14 may be or may not be a touch screen. The LAN I/F 16 is an I/F for communication via the LAN 4 and is connected to the LAN 4.

The controller 30 comprises a CPU 32 and a memory 34. The memory 34 comprises a volatile memory and a non-volatile memory. The volatile memory includes, for example, a RAM and a cache memory. The non-volatile memory includes, for example, a ROM, a flash memory, a solid state drive (SSD), a hard disk drive (HDD), or a combination thereof. An OS program 36 and an application 42 are stored in the non-volatile memory. The OS program 36 is a program for controlling basic operations of the terminal device 10. The application 42 is an application program for communication with the MFP 100. The application 42 is downloaded to the terminal device 10, for example, from a server (not shown) on the internet. The application 42 is provided, for example, by the vendor of the MFP 100. Various processes are implemented by the programs 36 and 42 stored in the non-volatile memory being loaded to the volatile memory and the CPU 32 executing the programs 36 and 42.

### Configuration of MFP 100: FIG. 1

The MFP 100 stores firmware 102, an automatic update setting value 104, and a password 106. The firmware 102 is a program for controlling the MFP 100. The firmware 102 is updated as needed. The latest version of the firmware 102 is uploaded to the server 200 by the vendor of the MFP 100.

The automatic update setting value 104 includes various setting values related to an automatic update function of the MFP 100 automatically updating the firmware 102. The automatic update setting value 104 includes an enablement setting value and a time setting value. The enablement setting value selectively indicates either “ON” meaning that the automatic update function is enabled or “OFF” indicating that the automatic update function is disabled. The time setting value indicates an update time when the version of the firmware 102 is to be updated to the latest version. In one aspect, the update time is, for example, 12:00 a.m. or the like. In another aspect, the update time is an interval such as every day, every week, every month, or the like. The “time” used herein may be rephrased as “schedule”. Thus, the update time may be rephrased as “update schedule”, and the time setting may be rephrased as “schedule setting”. According to the automatic update function, the MFP 100 inquires the server 200 whether the latest version of the firmware 102 is in the server 200 or not at the time of the time setting value at the interval of the time setting value. If the latest version of the firmware 102 is in the server 200, the MFP 100 downloads the latest version of the firmware 102 from the server 200 and updates the firmware 102 stored in the memory 34. That is, according to the automatic update function, the MFP 100 can update the firmware 102 stored in the memory 34 without receiving instructions from other devices (e.g., the terminal device 10) nor requiring user's operation on the operation unit 12.

The password 106 is used to authenticate a user of the MFP 100. The MFP 100 has a server function of supplying screen data for changing settings of the MFP 100 to an external terminal device. The server function is, for example, embedded web server (EWS). The password 106 is used, for example, to log into the MFP 100 operating as a server.

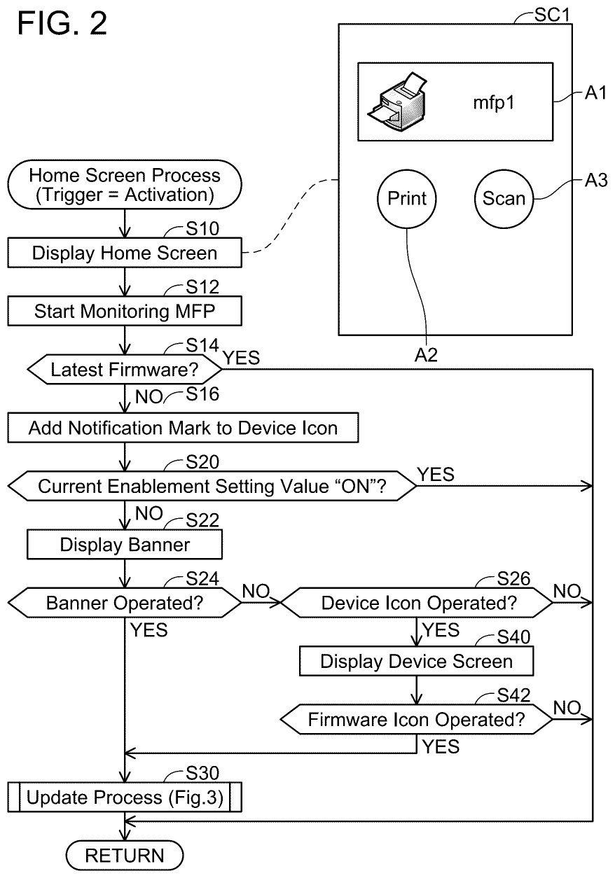

### Home Screen Process: FIGS. 2, 5, 7

Referring to FIG. 2, a home screen process executed by the CPU 32 according to the application 42 is described. The process of FIG. 2 is started in response to the application 42 being activated.

In S10, the CPU 32 causes the display 14 to display a home screen SC1. The home screen SC1 includes a device icon A1, a print icon A2, and a scan icon A3. The device icon A1 is an object that indicates a device designated by the application 42 as a target with which print data and scan data are to be communicated (this device is termed “target device” hereinafter). The device icon A1 shows a model name “mfp1” of the target device. The device icon A1 may further show an IP address of the target device.

The application 42 receives information, such as model names, IP addresses, and the like, from devices and uses the received information to accept designation of the target device. In the present case, the user has designated the MFP 100 as the target device via the application 42, and the application 42 has stored information of the MFP 100, such as its model name, serial number, IP address, and the like. The application 42 can store information of multiple devices, and the user can change the target device from the MFP 100 to another MFP by selecting the device icon A1.

The print icon A2 is an object for instructing the print process to be executed. In response to the print icon A2 being selected, the terminal device 10 displays a data selection screen for selection of image data to be printed and a preview screen including a preview image and a print button. In response to the print button being selected, the terminal device 10 sends print data corresponding to the selected image data and a print instruction to the target device.

The scan icon A3 is an object for instructing the scan process to be executed. In response to the scan icon A3 being selected, the terminal device 10 displays a screen including a scan setting input field and a scan button. In response to the scan button being selected, the terminal device 10 sends the target device a scan request that requests scan data to be sent.

In S12, the CPU 32 starts monitoring the target device. Specifically, the CPU 32 starts repeatedly receiving device information related to the target device from the target device. The device information includes the current version of the firmware 102, a remaining amount of color material housed in the target device, and information indicating the current operation state of the target device (e.g., “busy”). In the case where the target device is the MFP 100, the device information includes a current value which is the automatic update setting value 104 currently set in the MFP 100. If the automatic update setting value 104 has never been changed, the current value is a default value. Conversely, in the case where the target device is another MFP and this MFP does not support the automatic update function, the device information does not include any value related to the automatic update setting value 104. The device information received in S12 is stored in a predetermined storage area of the memory 34.

In S14, the CPU 32 determines whether the version of the firmware 102 in the target device is the latest version. Specifically, the CPU 32 first sends information indicative of the target device, such as its model name, to the server 200 to know the latest version of the firmware 102. The CPU 32 then determines whether the current version of the firmware 102 received in S12 matches the latest version received from the server 200. When the current version matches the latest version, the CPU 32 determines the version of the firmware 102 is the latest version. When determining that the version of the firmware 102 is the latest version (YES in S14), the CPU 32 skips S16 and all the following steps, and returns to S10.

When determining that the current version is older than the latest version, i.e., that the current version of the firmware 102 is not the latest version (NO in S14), the CPU 32 proceeds to S16.

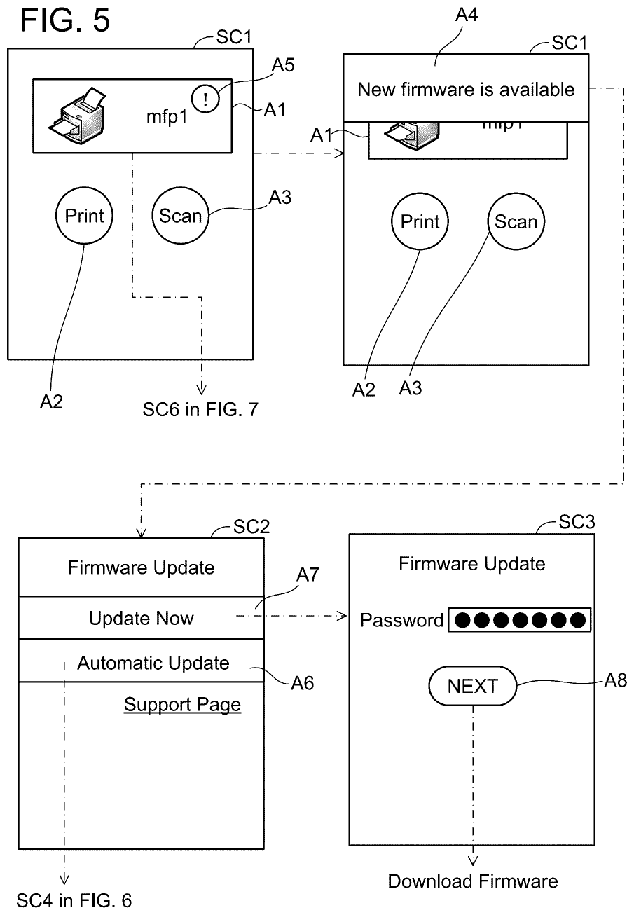

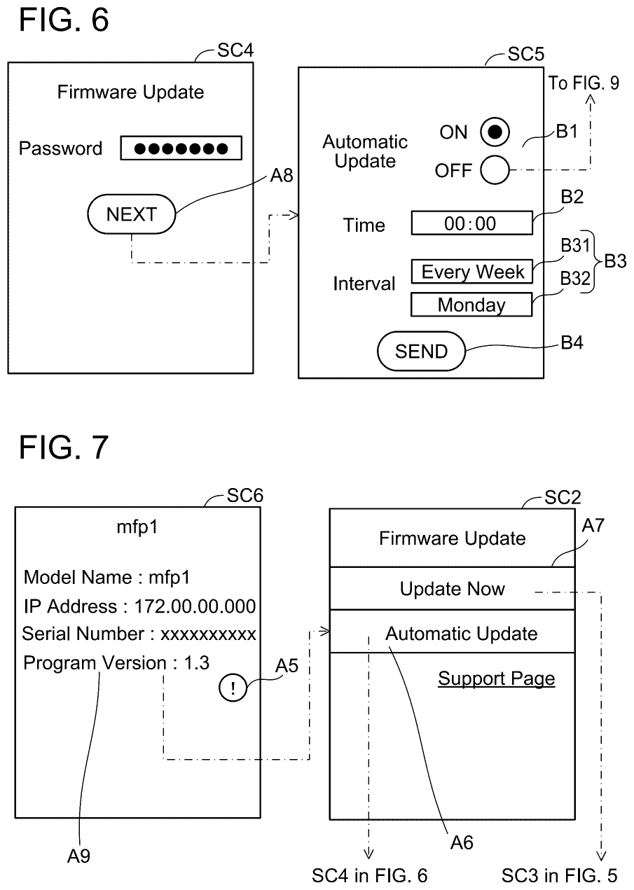

In S16, as shown in FIG. 5, the CPU 32 adds a predetermined notification mark A5 to the device icon A1 in the home screen SC1. This allows the user to visually recognize that the version of the firmware 102 is not the latest version through the notification mark A5.

In S20, the CPU 32 determines whether the current enablement setting value included in the device information received in S12 indicates “ON”. When determining that the current enablement setting value indicates “ON” (YES in S20), the CPU 32 skips S22 and all the following steps, and returns to S10.

When determining that the current enablement setting value indicates “OFF” (NO in S20), the CPU 32 proceeds to S22. In S22, the CPU 32 causes the display 14 to display a banner screen A4 over the home screen SC1, as shown in FIG. 5. The banner screen A4 is a so-called pop-up notification and may be called a toast. The banner screen A4 includes a message indicating that the latest version of the firmware 102 is available. The message shown in FIG. 5 is merely an example, and the message may say “The current version of the firmware is not the latest version.”, “Would you like to update the firmware to the latest version?”, or the like. The banner screen A4 allows the user to visually recognize that the current version of the firmware 102 is not the latest version. Especially, since the banner screen A4 is displayed when the current enablement setting value indicates “OFF”, the banner screen A4 allows the use to know the presence of the automatic update function.

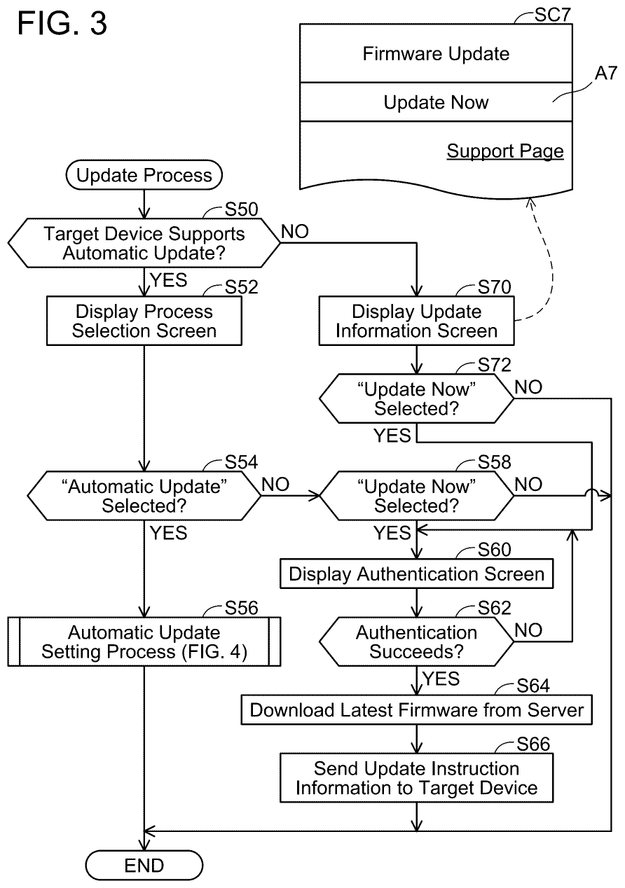

In S24, the CPU 32 determines whether an operation has been performed on the banner screen A4 via the operation unit 12. This operation is, for example, touching the banner screen A4. When determining that an operation has been performed on the banner screen A4 via the operation unit 12 (YES in S24), the CPU 32 proceeds to S30. In S30, the CPU 32 executes an update process, which will be described later referring to FIG. 3. When S30 is completed, the CPU 32 returns to S10.

When determining that the banner screen A4 was closed (NO in S24), the CPU 32 proceeds to S26. In S26, the CPU 32 determines whether an operation has been performed on the device icon A1 via the operation unit 12. When determining that an operation has been performed on the device icon A1 via the operation unit 12 (YES in S26), the CPU 32 proceeds to S40. The banner screen A4 is displayed when the current enablement setting value indicates “OFF”, while the device icon A1 is displayed even when the current enablement setting value indicates “ON”. When an operation on the device icon A1, which is displayed even when the current enablement setting value indicates “ON”, is performed, S40 and S42 are executed and S30 may be executed thereafter.

In S40, the CPU 32 causes the display 14 to display a device screen SC6 shown in FIG. 7. The device screen SC6 displays information related to the target device. The device screen SC6 includes a firmware icon A9 in addition to the information such as the model name, etc. The firmware icon A9 shows the current version of the firmware 102 in the target device. If the version of the firmware 102 in the target device is not the latest version, the firmware icon A9 is accompanied by the notification mark A5. Showing the notification mark A5 on the device screen SC6 again allows the user to visually recognize that the version of the firmware 102 is not the latest version through the device screen SC6.

In S42, the CPU 32 determines whether an operation has been performed on the firmware icon A9 accompanied by the notification mark A5 via the operation unit 12. When determining that an operation has been performed on the firmware icon A9 accompanied by the notification mark A5 via the operation unit 12 (YES in S42), the CPU 32 proceeds to S30.

When determining that an operation has not been performed on the device icon A1 via the operation unit 12 (NO in S26) and when determining that the device screen SC6 was closed without an operation being performed on the firmware icon A9 via the operation unit 12 (NO in S42), the CPU 32 returns to S10.

### Update Process: FIGS. 3 and 5

In S50, the CPU 32 determines whether the target device supports the automatic update function. For example, there is a database in which each device model name is stored in association with corresponding support information indicating whether the device supports the automatic update function or not. The CPU 32 determines whether the target device supports the automatic update function based on the support information associated with the model name of the target device in the database. This database may be stored in the application 42 or a server on the internet 6. Alternatively, the CPU 32 may receive support information from the target device and determine whether the target device supports the automatic update function based on the support information received from the target device. The support information may be included, for example, in the device information received in S12 of FIG. 2. When determining that the target device supports the automatic update function (YES in S50), the CPU 32 proceeds to S52.

In S52, the CPU 32 causes the display 14 to display a process selection screen SC2 shown in FIG. 5. The process selection screen SC2 is a screen for selection of a process related to the update of the firmware 102. The process selection screen SC2 includes a first object A6, a second object A7, and a link to a support page. The first object A6 is an object for instructing the update using the automatic update function (this update is termed “automatic update” hereinafter). It should be noted here that an object has a concept including a button, an icon, a banner, etc. For example, the object A6, etc. are not limited to banners shown in FIG. 5 and may be buttons or icons. The second object A7 is an object for instructing the update without using the automatic update function (this update is termed “update now”). The link to a support page includes an URL of a support page that describes how to update using the automatic update function and how to update without using the automatic update function. In response to the link to the support page being selected, the CPU 32 activates a Web browser and supplies the URL included in the link to the Web browser. As a result, the support page is displayed on the display 14. In a modification, the CPU 32 may cause the display 14 to display the support page using a browser function of the application 42.

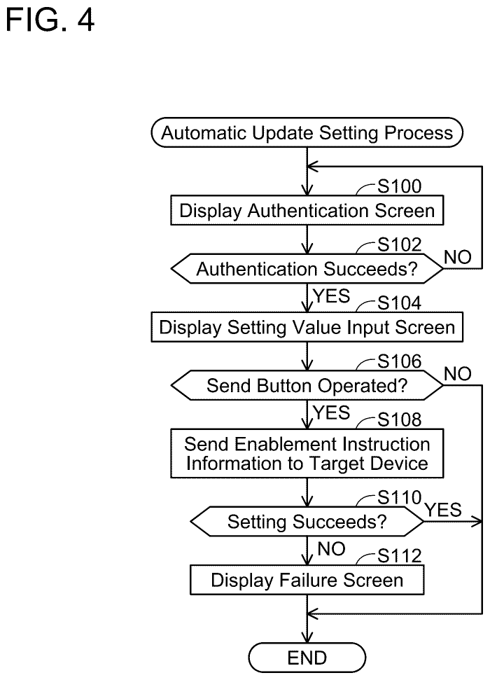

In S54, the CPU 32 determines whether an operation of selecting the first object A6 has been performed via the operation unit 12. When determining that the first object A6 has been selected (YES in S54), the CPU 32 proceeds to S56. In S56, the CPU 32 executes an automatic update setting process, which will be described later referring to FIG. 4. When S56 is completed, the CPU 32 ends the process of FIG. 3.

When determining that the first object A6 has not been selected (NO in S54), the CPU 32 proceeds to S58. In S58, the CPU 32 determines whether an operation of selecting the second object A7 has been performed via the operation unit 12. When determining that the second object A7 has been selected (YES in S58), the CPU 32 proceeds to S60.

In S60, the CPU 32 displays an authentication screen SC3 shown in FIG. 5. The authentication screen SC3 includes a password input field and an instruction button A8 for instructing authentication to be executed. When an operation is performed on the instruction button A8 via the operation unit 12, the CPU 32 sends a password inputted to the password input field to the target device. The target device checks the password received from the terminal device 10 against the password 106 stored in the target device. When the password received from the terminal device 10 matches the password 106 stored in the target device, the target device sends an authentication success notification to the terminal device 10. When the password received from the terminal device 10 does not match the password 106 stored in the target device, the target device sends an authentication failure notification to the terminal device 10.

In S62, the CPU 32 determines whether the authentication of the password inputted in the password input field in the authentication screen SC3 has succeeded. When determining that the authentication has failed based on the authentication failure notification received from the target device (NO in S62), the CPU 32 returns to S60. In the case of failure of the authentication, a message indicating that the authentication has failed or a message prompting re-entry of a password may be displayed in the authentication screen SC3. When determining that the authentication has succeeded based on the authentication success notification received from the target device (YES in S62), the CPU 32 proceeds to S64. The configuration above prevents a third party that is not permitted to use the target device from proceeding to S64 and S66, which will be described later.

In S64, the CPU 32 downloads (i.e., receives) the latest version of the firmware 102 from the server 200. In S66, the CPU 32 sends update instruction information that instructs the update of the firmware 102 in the target device to the target device. The update instruction information includes the latest version of the firmware 102 downloaded from the server 200. The target device updates the firmware 102 therein according to the update instruction information received from the terminal device 10. When S66 is completed, the process of FIG. 3 ends. For example, a comparative example is conceivable in which the target device downloads the latest version of the firmware 102. In the present embodiment, the terminal device 10 downloads the latest version of the firmware 102 instead of the target device, which reduces a processing load on the target device. In a modification, the above comparative example may be used.

While the process selection screen SC2 is kept displayed without the object A6 or the object A7 being selected in the process selection screen SC2, the CPU 32 repeats the determinations of S54 and S58. For example, the CPU 32 closes the process selection screen SC2 in response to the user performing a predetermined operation. In a modification, the CPU 32 may close the process selection screen SC2 after a predetermined time period (e.g., three seconds) from when the process selection screen SC2 was displayed. In the present embodiment, when closing the process selection screen SC2, the CPU 32 makes the determination NO in S58 and ends the process of FIG. 3.

When determining that the target device does not support the automatic update function (NO in S50), the CPU 32 proceeds to S70. In S70, the CPU 32 causes the display 14 to display an update information screen SC7 for the update of the firmware 102. The update information screen SC7 is identical to the process selection screen SC2 except that the former does not include the first object A6. That is, when the target device does not support the automatic update function, input related to the automatic update is limited. The configuration above allows the user to avoid performing unnecessary operations when the target device does not support the automatic update function.

In S72, the CPU 32 determines whether the second object A7 in the update information screen SC7 has been selected. When determining that the second object A7 has been selected (YES in S72), the CPU 32 proceeds to S60. Conversely, when determining that the update information screen SC7 was closed without the second object A7 being selected (NO in S72), the CPU 32 ends the process of FIG. 3.

### Automatic Update Setting Process: FIGS. 4, 6, and 9

In S100, the CPU 32 causes the display 14 to display an authentication screen SC4 shown in FIG. 6. The authentication screen SC4 is identical to the authentication screen SC3 shown in FIG. 5, but steps executed after the authentication succeeded through the authentication screen SC4 are different from those executed after the authentication succeeded through the authentication screen SC3 shown in FIG. 5. S102 is the same as S62 in FIG. 3. The configuration above prevents the automatic update setting value 104 from being changed by a third party that is not permitted to user the MFP 100.

When determining that the authentication succeeded (YES in S102), the CPU 32 proceeds to S104. In S104, the CPU 32 generates a setting value input screen SC5 shown in FIG. 6 and causes the display 14 to display the setting value input screen SC5. The setting value input screen SC5 includes an enablement instruction input field B1, a time input field B2, an interval input field B3, and a send button B4. The enablement instruction input field B1 includes radio buttons for selecting either “ON” or “OFF” as the enablement setting value of the automatic update setting value 104. The time input field B2 includes an input field to which a time is inputted as the time setting value of the automatic update setting value 104. The interval input field B3 includes two fields B31 and B32 to which an interval is inputted as the time setting value of the automatic update setting value 104. For example, if “every week” is inputted to the field B31, a day of the week can be inputted to the field B32, while if “every month” is inputted to the field B31, a day of the month can be inputted to the field B32. For example, texts may be directly inputted to the time input field B2 and the interval input field B3, or values may be selected from lists as input to the time input field B2 and the interval input field B3. Here, the lists may be displayed in a pull-down manner in the fields, or may be dynamic lists called such as drumroll, picker, etc. The send button B4 is a button for instructing the values inputted to the fields B1 to B3 to be sent to the target device.

The setting value input screen SC5 shown in FIG. 6 corresponds to a case where the enablement setting value “ON” is selected in the enablement instruction input field B1. In this case, input of values to the time input field B2 and the interval input field B3 is permitted. On the other hand, the setting value input screen SC5 shown in FIG. 9 corresponds to a case where the enablement setting value “OFF” is selected in the enablement instruction input field B1. In this case, the time input field B2 and the interval input field B3 are grayed out, and thus input of values to the time input field B2 and the interval input field B3 is limited. This prevents unnecessary input of a time setting value when the enablement setting value is “OFF”. In a modification, when the enablement setting value “OFF” is selected in the enablement instruction input field B1 in the setting value input screen SC5, the time input field B2 and the interval input field B3 may disappear from the setting value input screen SC5.

The current value of the time setting value received from the target device in S12 of FIG. 2 is reflected as an initial value in the time input field B2 and the interval input field B3 (i.e., the current value is already shown in the field B2 and B3 when the setting value input screen SC5 is displayed). This reflection of the current value saves the user time and effort of inputting values. In a modification, the current value of the time setting value may not be reflected in the time input field B2 and the interval input field B3.

In S106, the CPU 32 determines whether an operation has been performed on the send button B4 in the setting value input screen SC5 via the operation unit 12. When determining that an operation has been performed on the send button B4 via the operation unit 12 (YES in S106), the CPU 32 proceeds to S108. In S108, the CPU 32 sends enablement instruction information for instructing the automatic update function to be enabled to the target device. The enablement instruction information is a command according to, for example, Management Information Base (MIB). The enablement instruction information includes the values inputted to the fields B1 to B3. The target device changes the automatic update setting value 104 in the target device according to the enablement instruction information received from the terminal device 10 to enable the automatic update function.

In S110, the CPU 32 determines whether the automatic update function has been successfully enabled according to the enablement instruction information. When determining that the automatic update function has been successfully enabled (YES in S110), the CPU 32 skips S112, which will be described later, and ends the process of FIG. 4.

When determining that the automatic update function has not been successfully enabled according to the enablement instruction information (NO in S110), the CPU 32 proceeds to S112. In S112, the CPU 32 causes the display 14 to display a failure screen indicating that the automatic update function was not successfully enabled. The automatic update function is not successfully enabled, for example, when communication between the terminal device 10 and the target device is interrupted, when communication between the target device and the server 200 is interrupted, and/or when unavailable value(s) are included in the enablement instruction information as the automatic update setting value 104. For example, when communication between the terminal device 10 and the target device is interrupted, the CPU 32 time outs without receiving a response from the target device. In this case, the CPU 32 determines that the automatic update function was not successfully enabled. Alternatively, for example, when communication between the target device and the server 200 is interrupted, the CPU 32 receives from the target device a response indicative of the communication malfunction and thereby determines that the automatic update function was not successfully enabled. The failure screen allows the user to visually recognize that the automatic update function was not successfully enabled. After S112 is completed, the CPU 32 ends the process of FIG. 4. In a modification, a voice notification may be used instead of the failure screen.

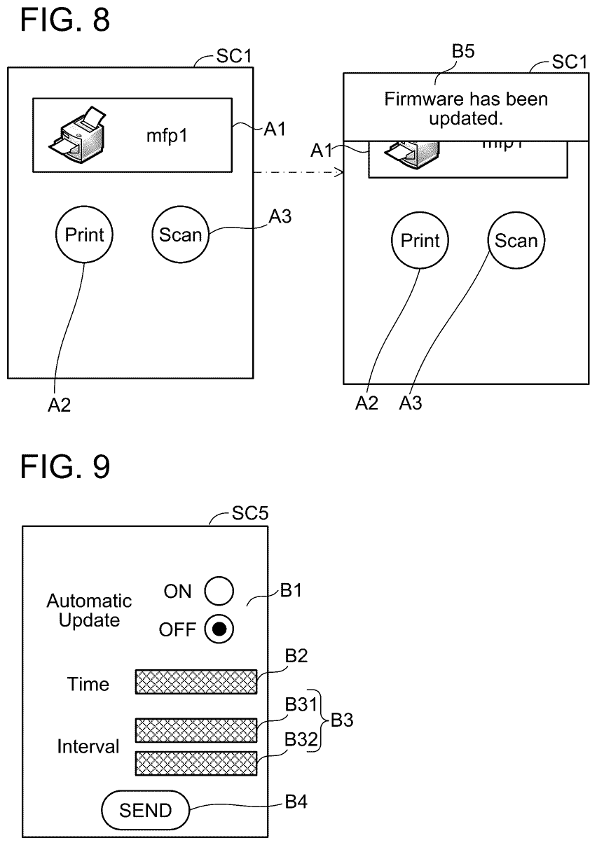

### Process to Notify Update Result: FIG. 8

As described above, the device information received in S12 of FIG. 2 is stored in a predetermined storage area of the memory 34. After the enablement instruction information has been sent to the target device in the automatic update setting process shown in FIG. 4, the CPU 32 executes S12 of FIG. 2 again. When the version included in device information received from the target device after the enablement instruction information has been sent to the target device is newer than the version that was included in the past device information and is stored in the predetermined storage area, the CPU 32 causes the display 14 to display a banner screen B5 over the home screen SC1. The banner screen B5 is displayed over a part of the device icon A1 but is not displayed over the other icons A2 and A3. The user can thus perform operations on the icons A2 and A3 while the banner screen B5 is being displayed. The banner screen B5 includes a message indicating that the firmware 102 has been updated. The banner screen B5 allows the user to visually recognize that the firmware 102 has been updated. In a modification, a voice notification may be used instead of the banner screen B5.

### Advantageous Effects of Embodiment

According to the configuration of the embodiment, the user can select, in the process selection screen SC2 shown in FIG. 5, either sending the enablement instruction information (S106 in FIG. 4) or sending the update instruction information (S66 in FIG. 3) as a process related to the update of the firmware 102. The use is prompted to update the firmware 102 after multiple ways to update the firmware 102 are presented to the user.

According to the configuration of the embodiment, the user can set a time setting value for the automatic update function via the setting value input screen SC5 in FIG. 6 displayed at the terminal device 10. Thus, the user can easily set an update time using the terminal device 10 which is easier to operate than the MFP 100.

The setting value input screen SC5 is displayed in response to an operation being performed on the banner screen A4 (YES in S24 of FIG. 2) or an operation being performed on the device icon A1 with the notification mark A5 (YES in S26). Thus, the user is prompted to input a time setting value at a time when the update to the latest version of the firmware 102 is recommended.

Even when the version of the firmware 102 is the latest version, the process section screen SC2 may be displayed in response to the firmware icon A9 being selected. When the version of the firmware 102 is the latest version, the process selection screen SC2 may not include the second object A7 (i.e., “update now”).

### Correspondence Relationships

The terminal device 10, the display 14, and the LAN I/F 16 are examples of “terminal device”, “display”, and “communication interface”, respectively. The application 42 and the controller 30 are examples of “computer-readable recording medium storing computer-readable instructions” and “a processor”, respectively. The MFP 100 and the firmware 102 are examples of “device” and “device program”, respectively. The setting value input screen SC5 is an example of “input screen”. The time input field B2 and the interval input field B3 are examples of “first input field”. The enablement instruction input field B1 is an example of “second input field”. The time setting value of the automatic update setting value 104 and the enablement setting value of the automatic update setting value 104 are examples of “time setting value” and “specific setting value”, respectively. The enablement setting value “OFF” and “ON” are examples of “first value” and “second value”, respectively. The authentication screen SC4 shown in FIG. 6 is an example of “authentication screen”. The failure screen displayed in S112 of FIG. 4 is an example of “first notification”. The banner screen B5 shown in FIG. 8 is an example of “second screen”. The banner screen A4 shown in FIG. 5 and the notification mark A5 are examples of “notification object”.

S104 and S108 in FIG. 4 are examples of “cause the display to display an input screen” and “send a value inputted in the first input field to the device”, respectively.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described invention are provided below:

### Modification 1

The “device” is not limited to the MFP 100 and may be, for example, a printer, a scanner, or a FAX machine.

### Modification 2

The “device program” is not limited to the firmware 102 and may be software of a higher layer than firmware or a combination of firmware and software of a higher layer.

### Modification 3

The setting value input screen SC5 shown in FIG. 6 may not include the enablement instruction input field B1. In this modification, “second input field” may be omitted. Alternatively, the setting value input screen SC5 may include one of the time input field B2 and the interval input field B3 and may not include the other of the time input field B2 and the interval input field B3. In this modification, the one of the time input field B2 and the interval input field B3 is an example of “first input field”.

### Modification 4

S100 in FIG. 4 may not be executed. In this modification, “authentication screen” may be omitted.

### Modification 5

S50, S70, and S72 in FIG. 3 may not be executed. In this modification, “specific information” may be omitted.

### Modification 6

The update information screen SC7 shown in FIG. 3 may include the first object A6 displayed in a gray-out manner. Even when the grayed-out first object A6 is selected, the CPU 32 does not execute the automatic update setting process shown in FIG. 4, and input of a time setting value is limited.

### Modification 7

S112 in FIG. 4 may not be executed. In this modification, “first notification” may be omitted.

### Modification 8

The banner screen B5 shown in FIG. 8 may not be displayed. In this modification, “second notification” may be omitted.

### Modification 9

The banner screen A4 and the notification mark A5 shown in FIG. 5 may not be displayed. In this modification, for example, when an operation is performed on the firmware icon A9 without the notification mark A5 via the operation unit 12, the terminal device 10 may display the setting value input screen SC5. In this modification, “notification object” may be omitted.

### Modification 10

S20 in FIG. 4 may not be executed. In this modification, when the enablement setting value indicates “ON”, a setting value input screen SC5 that does not include the enablement instruction input field B1 and includes the other fields B2 and B3 may be displayed.

### Modification 11

In the embodiment above, the processes of FIGS. 2 to 9 are implemented by the CPU 32 executing the application 42. Instead of this, at least one of the processes may be implemented by hardware such as a logic circuit.

What is claimed is:

1. A non-transitory computer-readable recording medium storing computer-readable instructions for a terminal device,
the computer-readable instructions, when executed by a processor of the terminal device, causing the terminal device to:
cause a display of the terminal device to display an input screen including a first input field for setting a time setting value indicating a time when a device being configured to communicate with the terminal device is to execute an automatic update function, the input screen being generated according to the computer-readable instructions, and the automatic update function being a function for automatically updating a device program stored in the device at a time indicated by the time setting value; and
send a value inputted in the first input field to the device via a communication interface of the terminal device, the value inputted in the first input field being used in the device as the time setting value.

2. The non-transitory computer-readable recording medium according to claim 1, wherein
the input screen further includes a second input field for inputting one of a first value and a second value as a specific setting value to be set in the device,
the first value indicates that the automatic update function is disabled,
the second value indicates that the automatic update function is enabled,
input to the first input field is accepted in a case where the second value is inputted to the second input field,
input to the first input field is limited in a case where the first value is inputted to the second input field, and
the values inputted in the first input field and the second input field are sent to the device.

3. The non-transitory computer-readable recording medium according to claim 1, wherein
the computer-readable instructions, when executed by the processor, further cause the terminal device to cause the display to display an authentication screen for authenticating a user of the device, and
the display is caused to display the input screen in a case where authentication of the user succeeds on the authentication screen.

4. The non-transitory computer-readable recording medium according to claim 1, wherein
input to the first input field is accepted in a case where the terminal device receives, from the device, specific information indicating that the device is capable of executing the automatic update function, and
input to the first input field is limited in a case where the terminal device does not receive the specific information from the device.

5. The non-transitory computer-readable recording medium according to claim 1, wherein
the computer-readable instructions, when executed by the processor, further cause the terminal device to receive a current value which is currently set in the device as the time setting value from the device via the communication interface, and
the current value is reflected as an initial value in the first input field.

6. The non-transitory computer-readable recording medium according to claim 1, wherein
the computer-readable instructions, when executed by the processor, further cause the terminal device to, in a case where setting the time setting value in the device based on the value inputted in the input screen fails, output a first notification indicating that the setting has failed.

7. The non-transitory computer-readable recording medium according to claim 1, wherein
the computer-readable instructions, when executed by the processor, further cause the terminal device to:
repeatedly receive a version of the device program stored in the device from the device via the communication interface; and
in a case where the version received from the device after the value inputted in the input screen has been sent to the device is newer than the version received from the device before the value inputted in the input screen is sent to the device, output a second notification indicating that the automatic update function has been executed.

8. The non-transitory computer-readable recording medium according to claim 1, wherein
the computer-readable instructions, when executed by the processor, further cause the terminal device to cause the display to display a notification object related to update of the device program, and
the display is caused to display the input screen in response to accepting an operation on the notification object.

9. The non-transitory computer-readable recording medium according to claim 1, wherein
the device is configured to execute a print function, and
the device is designated by the computer-readable instructions as a target to which print data is to be sent.

10. A terminal device comprising:
a display;
a communication interface; and
a controller configured to:
cause the display to display an input screen including a first input field for setting a time setting value indicating a time when a device, which is configured to communicate with via the communication interface, is to execute an automatic update function, wherein the automatic update function is a function for automatically updating a device program stored in the device at a time indicated by the time setting value; and
send a value inputted in the first input field to the device via the communication interface, wherein the value inputted in the first input field is used in the device as the setting time setting value.

11. A control method for a terminal device, the control method comprising:
causing a display of the terminal device to display an input screen including a first input field for setting a time setting value indicating a time when a device, which is configured to communicate with via a communication interface of the terminal device, is to execute an automatic update function, the automatic update function being a function for automatically updating a device program stored in the device at a time indicated by the time setting value; and
sending a value inputted in the first field to the device via the communication interface, the value inputted in the first input field being used in the device as the setting time setting value.

12. The control method according to claim 11, wherein
the input screen further includes a second input field for inputting one of a first value and a second value as a specific setting value to be set in the device,
the first value indicates that the automatic update function is disabled,
the second value indicates that the automatic update function is enabled,
input to the first input field is accepted in a case where the second value is inputted to the second input field,
input to the first input field is limited in a case where the first value is inputted to the second input field, and
the values inputted in the first input field and the second input field are sent to the device.

13. The control method according to claim 11, wherein
the control method further comprises causing the display to display an authentication screen for authenticating a user of the device, and
the display is caused to display the input screen in a case where authentication of the user succeeds on the authentication screen.

14. The control method according to claim 11, wherein
input to the first input field is accepted in a case where the terminal device receives, from the device, specific information indicating that the device is capable of executing the automatic update function, and
input to the first input field is limited in a case where the terminal device does not receive the specific information from the device.

15. The control method according to claim 11, wherein
the control method further comprises receiving a current value which is currently set in the device as the time setting value from the device via the communication interface, and
the current value is reflected as an initial value in the first input field.

16. The control method according to claim 11, wherein
the control method further comprises, in a case where setting the time setting value in the device based on the value inputted in the input screen fails, outputting a first notification indicating that the setting has failed.

17. The control method according to claim 11, wherein
the control method further comprises:
repeatedly receiving a version of the device program stored in the device from the device via the communication interface; and
in a case where the version received from the device after the value inputted in the input screen has been sent to the device is newer than the version received from the device before the value inputted in the input screen is sent to the device, outputting a second notification indicating that the automatic update function has been executed.

18. The control method according to claim 11, wherein
the control method further comprises causing the display to display a notification object related to update of the device program, and
the display is caused to display the input screen in response to accepting an operation on the notification object.

19. The control method according to claim 11, wherein
the device is configured to execute a print function, and
the device is designated by the computer-readable instructions as a target to which print data is to be sent.
